(19) United States
(12) Patent Application Publication
(10) Pub. No.: US 2007/0211138 A1
(43) Pub. Date: Sep. 13, 2007

(54) System and method for configuring devices to facilitate video telephony

(75) Inventors: Philip R. Graham, Milpitas, CA (US); Randy K. Harrell, Los Gatos, CA (US); Marthinus F. De Beer, Los Gatos, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/373,445

(22) Filed: Mar. 9, 2006

(51) Int. Cl. H04N 7/14

(52) U.S. Cl. 348/14.01

(57) ABSTRACT

A system and method for configuring devices to facilitate video telephony includes providing at least two devices that support video or audio communication. One of the devices is identified as a master device, and at least one of the devices is identified as a slave device. Media capabilities of the master device are determined, and the media capabilities of the slave device are received. The media capabilities of the master device and the slave device are aggregated, and the aggregated media capabilities are communicated to a remote site to facilitate video telephony.

### TECHNICAL FIELD

This invention relates generally to the field of telecommunications and more specifically to a system and method for configuring devices to facilitate video telephony.

### BACKGROUND

Traditional video telephony equipment is built such that the components are in a single enclosure that each handles audio and video encoding and decoding for transmission of audio and video over a network. Some systems support audio and video for a single display, camera, and limited audio, while other systems offer the ability to have extra cameras and displays. When additional displays are needed, one traditional approach provides a larger enclosure to house more audio and video hardware and software and provides additional audio and video inputs and outputs as required. This leads to an inflexible system that does not support continued growth.

### SUMMARY OF THE DISCLOSURE

In accordance with the present invention, disadvantages and problems associated with previous techniques for configuring devices to facilitate video telephony may be reduced or eliminated.

According to one embodiment of the present invention, a system and method for configuring devices to facilitate video telephony includes providing at least two devices that support video or audio communication. One of the devices is identified as a master device, and at least one of the devices is identified as a slave device. Media capabilities of the master device are determined, and the media capabilities of the slave device are received. The media capabilities of the master device and the slave device are aggregated, and the aggregated media capabilities are communicated to a remote site to facilitate video telephony.

According to another embodiment, a system and method for providing media capabilities to a master device for aggregation to facilitate video telephony includes providing at least two devices that support video or audio communication. One of the devices is identified as a master device, and at least one of the devices is identified as a slave device. Media capabilities are provided to the master device for aggregation to facilitate video telephony.

Certain embodiments of the invention may provide one or more technical advantages. A technical advantage of one embodiment includes configuring a videoconferencing system (VCS) from one or more devices without knowledge of the number of components to accomplish the video telephony. Another technical advantage of another embodiment includes discovering components as they are added to the system. For example, when components are added to the system, the VCS discovers the added components and reconfigures to handle the components. Yet another technical advantage of another embodiment includes minimizing user interaction with the technology. Therefore, the system dynamically configures itself without substantial manual configuration.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a system for video telephony;

FIG. 2 is a flowchart for configuring a master device and slave devices into a VCS;

FIG. 3 is a flowchart for receiving media over a network and communicating the media within a local site;

FIG. 4 is a flowchart for configuring a slave device and communicating a video stream to the master device according to the configuration; and

FIG. 5 is a flowchart for receiving a video stream from the master device.

### DETAILED DESCRIPTION OF THE DRAWINGS

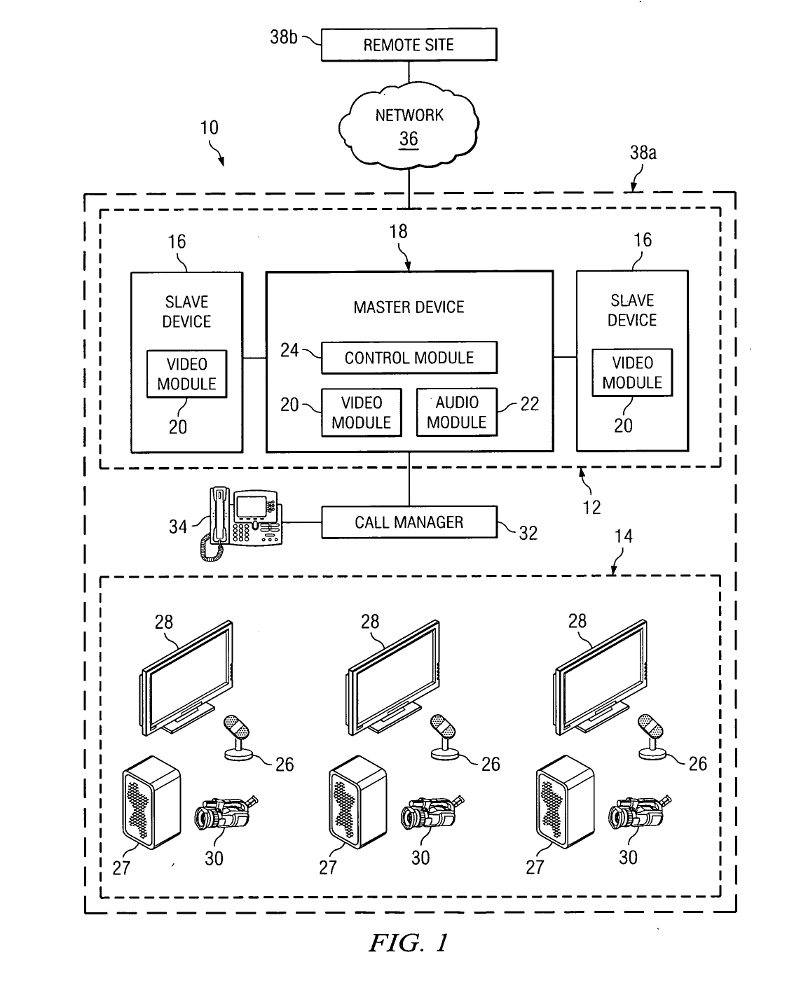

Embodiments of the present invention and its advantages are best understood by referring to FIGS. 1 through 5 of the drawings, like numerals being used for like and corresponding parts of the various drawings.

FIG. 1 is a block diagram illustrating a system 10 for video telephony. The illustrated embodiment includes slave devices 16 and a master device 18 that operate as a VCS 12 to facilitate video telephony over network 36. In an embodiment, VCS 12 appears to a user as a single unit. Each slave device 16 and master device 18 drive a display 28 and a camera 30 at sites 38. System 10 provides for reconfiguring VCS 12 to provide additional media capabilities as equipment 14 is added at site 38 without manual configuration and with minimal user intervention.

Video telephony is a communication session that facilitates the exchange of video and audio streams. The video telephony session at site 38 may occur as an inbound call, an outbound ad-hoc call, a scheduled call, a conference call, a business to business call, or other suitable call scenario.

Video telephony occurs between sites 38 over network 36. System 10 includes any suitable number of sites 38 that participate in video telephony. FIG. 1 includes an exemplary embodiment of local site 38a. Remote site 38b may be organized similarly to local site 38a or any other suitable manner to facilitate video telephony.

Network 36 represents communication equipment, including hardware and any appropriate controlling logic, for interconnecting elements coupled to network 36 and facilitating communication between sites 38. Network 36 may include a local area network (LAN), a metropolitan area network (MAN), a wide area network (WAN), any other public or private network, a local, regional, or global communication network, an enterprise intranet, other suitable wireline or wireless communication link, or any combination of the preceding. Network 36 may include any combination of gateways, routers, hubs, switches, and any other hardware, software, or a combination of the preceding that may implement any suitable protocol or communication.

VCS 12 facilitates video telephony by providing for the operation of physically separate devices as a VCS 12 and by reconfiguring if changes occur in system 10. VCS 12 includes any suitable hardware and/or software to facilitate communication over multiple channels or over a concatenated channel. Software of VCS 12 dynamically configures its operation to support the hardware of VCS 12. In the illustrated embodiment, hardware of VCS 12 includes a master device 18 and any suitable number of slave devices 16 that self configure to operate as VCS 12. For example, VCS 12 includes one master device 18 and no slave devices 16. As another example, VCS 12 includes one master device 18 and one slave device 16.

Slave device 16 includes any suitable hardware and/or software to operate as a receiver and a transmitter of video streams. For example, slave device 16 receives a video stream from an associated camera 30 and transmits a video stream to an associated display at site 38. Each slave device 16 also provides the video stream received from camera 30 to master device 18 for aggregation. Slave device 16 includes a video module 20 that provides for encoding and decoding video streams. For example, video module 20 includes an encoder and a decoder. Video module 20 encodes the video stream using any suitable algorithm, such as H.263 and H.264. Additionally, video module 20 may receive and transmit any suitable number of video streams. For example, video module 20 receives a video stream from a main camera 30 and from a computer feed.

Master device 18 receives a video stream from each slave device 16 and from an associated camera 30. Master device 18 includes video module 20 to encode video streams received from its associated camera 30 and decode video streams transmitted to its associated display 28. In addition to video module 20, master device 18 includes an audio module 22. Master device 18 handles all audio functions of system 10. Audio module 22 compresses and decompresses one or more audio streams to and from VCS 12. Audio module 22 includes audio echo cancellation to filter and isolate unwanted audio signals. Master device 18 includes a control module 24 that controls all modules in VCS 12, including video module 20 and audio module 22. Control module 24 includes any suitable hardware, software, or both that operate to control the modules. For example, control module 24 includes a programmable logic device, a microcontroller, a microprocessor, any suitable processing device, or any combination of the preceding. For example, control module 24 initializes slave devices 16.

In the illustrated embodiment, master device 18 registers to a call manager 32, which controls sessions for system 10. Master device 18 registers with call manager 32 using a phone number, such as xxx-xxx-xxxx. Call manager 32 includes any suitable hardware and/or software to establish, control, and terminate communication sessions in response to requests from users, endpoints, telephony applications, or other suitable sources. Through master device 18, call manager 32 is aware of slave devices 16 and negotiates the communication capabilities of the session accordingly. If call manager 32 does not understand the capability exchange, master device 18 may negotiate this exchange directly with another master device 18 in a peer-to-peer configuration. Call manager 32 supports any suitable call control protocol, such as Session Initiation Protocol (SIP).

Endpoint 34 registers with call manager 32 to allow a user to interact with master device 18. Through a shared line with master device 18, endpoint 34 registers with call manager 32 using the same phone number master device 18 used. Endpoint 34 sends and receives data signals, audio signals, video signals, or any combination of the preceding. Endpoint 34 may include, for example, an Internet Protocol (IP) telephone or any other suitable endpoint for communication in system 10. Endpoint 34 supports any suitable protocol, such as IP or SIP.

Equipment 14 facilitates video telephony using any suitable components, such as microphones 26, speakers 27, displays 28, and cameras 30. Microphone 26 includes any suitable component that receives audio signals from a user. Speakers 27 include any suitable component that provides audio signals to a user. Multiple microphones 26 and speakers 27 provide for spatial distribution of audio at site 38. Audio signals received by multiple microphones 26 feed into audio module 22 in master device 18, and audio streams are transmitted from audio module 22.

Each camera 30 has an associated display 28 to provide a realistic experience. Displays 28 display images of participants in the video telephony session. Displays 28 include any suitable hardware and/or software to facilitate receiving a decoded video stream from VCS 12 and displaying the video stream as an image. For example, display 28 is a liquid crystal display (LCD) or a plasma display. Display 28 may provide for the physical display of a person in a life-size manner with a small deviation from physical characteristics. Each display 28 associates with a slave device 16 or a master device 18 from which to receive the decoded video stream. In the illustrated embodiment, each display 28 is adjacent to another display 28. Positioning displays 28 adjacent to each other encourages eye contact among participants.

Cameras 30 include any suitable hardware and/or software to facilitate capturing an image of participants and providing the image to other sites 38. For example, cameras 30 include a lens and an image processor. Cameras 30 capture and transmit the image as a video stream to VCS 12. Cameras 30 include a main view camera, a document camera, an overview camera, and/or any other suitable camera.

In operation, system 10 includes multiple devices that can be linked together through static or dynamic self-organization. When the devices self-organize, one device takes the role of master device 18 and the remaining devices take the role of slave devices 16. Organization of devices as slave devices 16 and master device 18 occur using any suitable protocol. For example, the device that detects inclusion of audio module 22 becomes master device 18. As another example, the device with the lowest IP address or the device with the longest availability may become master device 18.

Master device 18 discovers the capabilities of slave devices 16, and aggregates its capabilities and the capabilities of slave devices 16 as VCS 12. Because system 10 includes devices that self-organize and report capabilities as VCS 12, system 10 provides for self-reconfiguration if equipment 14 is added or removed, system 10 fails, or for any other suitable reason. For example, if a display 28 and camera 30 are added to site 38a, VCS 12 reconfigures to provide slave device 16 that receives video streams from the added camera 30 and transmits video streams to the added display 28. In the illustrated embodiment, master device 18 reports the aggregated capabilities to call manager 32 for use in video telephony sessions, or this may be communicated between master devices 18 in a peer-to-peer configuration.

As an exemplary embodiment of operation during an ad-hoc outbound communication session, a participant at local site 38a initiates a call. The user may use a standard interface to initiate the call. In an embodiment, the standard interface is endpoint 34 that uses existing signaling capabilities of call manager 32 to set up the call. Therefore, a user may easily initiate a call and use existing signaling capabilities of call manager 32. VCS 12 monitors the session's progress. If remote site 38b offers video capabilities and VCS 12 is not engaged in an active session, VCS 12 renegotiates the media and a video telephony session begins using VCS 12 and equipment 14. Endpoint 34 drops out of the session.

Modifications, additions, or omissions may be made while system 10 provides video telephony sessions. For example, site 38 may include any suitable number of microphones 26, speakers 27, displays 28, and cameras 30. Using multiple cameras 30 and displays 28 provides for capturing a complete image without panning, tilting, or zooming cameras 30. As another example, system 10 may not include call manager 32. In small-scale environments, call manager 32 may not be available. In this example, endpoint 34 is configured with enough services to still be used as a user interface. As yet another example, displays 28 and cameras 30 are high-definition to provide a realistic video telephony experience. Moreover, the operations of system 10 may be performed by more, fewer, or other components. Additionally, operations of system 10 may be performed using any suitable logic.

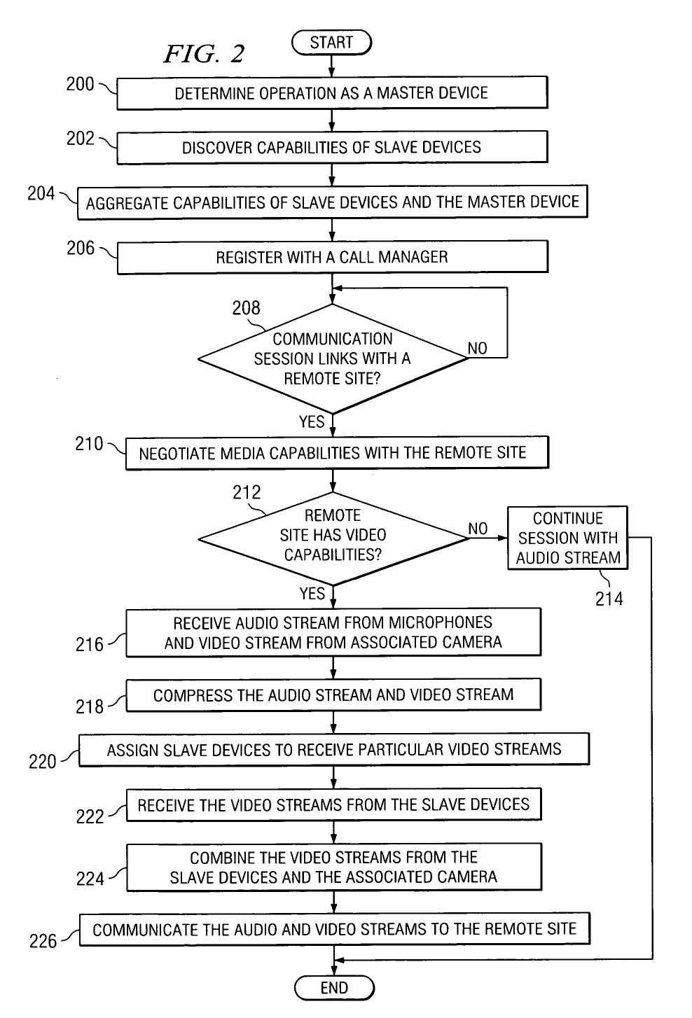

FIG. 2 is a flowchart for configuring master device 18 and slave devices 16 into VCS 12. At step 200, a device in system 10 determines its operation as master device 18 using any suitable protocol. If system 10 has other devices that operate as slave devices 16, master device 18 discovers the capabilities of slave devices 16 at step 202. For example, master device 18 obtains the IP addresses and configuration of slave devices 16. Master device 18 aggregates its capabilities and the capabilities of slave devices 16 at step 204. In an embodiment, master device 18 registers the aggregated capabilities with call manager 32 as VCS 12 at step 206. Registering with call manager 32 provides for cooperation with a standard interface to allow interaction with users.

At step 208, VCS 12 determines if a communication session occurs with remote site 38b. For example, a user at remote site 38b calls a user at local site 38a, or a user at local site 38a initiates the call. For an outbound call from local site 38a, VCS 12 monitors the call's progress to determine the capabilities remote site 38b offers. For an inbound call, VCS 12 offers its media capabilities during the call. The user may accept the media capabilities of VCS 12 or answer the call using endpoint 34. If a session is not established, VCS 12 continues to monitor incoming and outgoing calls. If a session is established, VCS 12 negotiates its media capabilities with remote site 38b at step 210. At step 212, VCS 12 determines whether remote site 38b has video capabilities. The communication session continues at step 214 using endpoint 34 with audio only if remote site 38b does not have video capabilities. If remote site 38b has video capabilities, a video telephony session may begin. Master device 18 receives audio streams from microphones 27 and a video stream from its associated camera 30 at step 216 during the video telephony session. Using video module 20 and audio module 22, master device 18 encodes the audio stream and video stream at step 218. Master device 18 receives the encoded video streams from slave devices 16 at step 220. Master device 18 combines the video streams from slave devices 16 and the video stream from its associated camera 30 at step 222. The audio and video streams are communicated to remote site 38b at step 224.

Modifications, additions, or omissions may be made to the flowchart in FIG. 2. For example, VCS 12 may not include slave devices 16. In this example, master device 18 does not discover capabilities, aggregate capabilities, receive video streams from slave devices 16, or combine video streams for communication. The flowchart may include more, fewer, or other steps. Additionally, steps may be performed in any suitable order and by any suitable component.

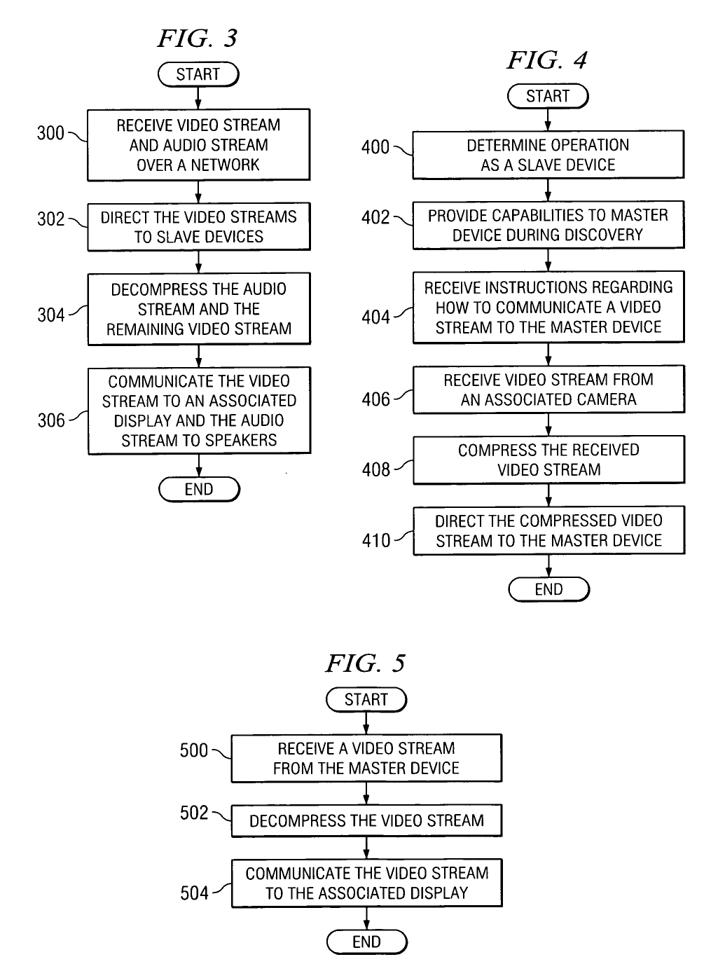

FIG. 3 is a flowchart for receiving media over network 36 and communicating the media within local site 38a. During a video telephony session, master device 18 receives media, which includes audio streams and video streams, over network 36 at step 300. If VCS 12 has slave devices 16, some of the video streams received are associated with slave devices 16. Master device 18 directs the video streams to their associated slave devices 16 at step 302.

Because the media is encoded for transmission over network 26, master device 18 decodes its associated video stream and the audio stream at step 304 using video module 20 and audio module 22, respectively. At step 306, master device communicates the decoded video stream to associated display 28 and the audio stream to speakers 27.

Modification, additions, or omissions may be made to the flowchart in FIG. 3. For example, master device 18 may receive its associated video stream and the audio stream only and not have to direct video streams to slave devices 16. In this example, slave devices 16 may receive their associated video stream directly from network 36. The flowchart may include more, fewer, or other steps. Additionally, steps may be performed in any suitable order and by any suitable component.

FIG. 4 is a flowchart for configuring slave device 16 and communicating a video stream to master device 18 according to the configuration. At step 400, the devices remaining after master device 18 takes control operate as slave devices 16. Depending on the configuration of system 10, any suitable number of devices operate as slave devices 16. For example, system 10 may have no slave device 16 or two slave devices 16.

At step 404, slave device 16 receives instructions regarding how to communicate a video stream to master device 18. During a video telephony session, slave device 16 receives a video stream from its associated camera 30 at step 406. Slave device 16 encodes the received video stream at step 408 with video module 20. Using the instructions received from master device 18, slave device 16 directs the encoded video stream to master device 18 at step 410. Throughout the video telephony session, slave device 16 communicates video streams to master device 18 for aggregation and communication over network 36.

Modifications, additions, or omissions may be made to the flowchart in FIG. 4. For example, slave device 16 may not receive instructions from master device 18, but may configure itself to communicate with master device 18 upon determining its operation as slave device 16. As another example, slave device 16 may not direct the video stream to master device 18 before aggregation with other video streams. The flowchart may include more, fewer, or other steps. Additionally, steps may be performed in any suitable order and by any suitable component.

FIG. 5 is a flowchart for receiving a video stream from master device 18. If site 38 participates in a video telephony session, slave device 16 receives a video stream from master device 18 at step 500. The video stream is associated with slave device 16. In an embodiment, master device 18 sends the video stream to slave device 16 upon receiving media over network 36. Because the video stream is encoded during communication over network 36, slave device 16 decodes the video stream at step 502. Slave device 16 uses video module 20 to decode the video stream. At step 504, slave device 16 communicates the video stream to its associated display 28.

Modifications, additions, or omissions may be made to the flowchart in FIG. 5. For example, slave device 16 may receive its associated video stream directly from network 36 rather than master device 18 distributing the video streams to slave devices 16. The flowchart may include more, fewer, or other steps. Additionally, steps may be performed in any suitable order and by any suitable component.

Although the present invention has been described in several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for configuring devices to facilitate video telephony, comprising:
providing at least two devices that support video or audio communication;
identifying one of the devices as a master device;
identifying at least one of the devices as a slave device;
determining media capabilities of the master device;
receiving the media capabilities of the slave device;
aggregating the media capabilities of the master device and the slave device; and
communicating the aggregated media capabilities to a remote site to facilitate video telephony.

2. The method of claim 1 further comprising registering the aggregated media capabilities with a call manager.

3. The method of claim 1, further comprising negotiating with a remote site to determine whether the remote site is operable to receive the aggregated media capabilities.

4. The method of claim 1, further comprising:
receiving a first video stream from an associated camera;
receiving an audio stream from one or more microphones;
encoding the first video stream and the audio stream;
receiving a second video stream from the slave device;
combining the second video stream from the slave device and the first video stream from the associated camera into a third video stream; and
communicating the audio stream and the third video stream to the remote site.

5. The method of claim 1, further comprising:
receiving a third video stream and an audio stream over a network, wherein the third video stream comprises a first video stream associated with the master device and a second video stream associated with the slave device;
communicating the second video stream to the slave device;
decoding the first video stream associated and the audio stream;
communicating the decoded video stream to an associated display; and
communicating the decoded audio stream to speakers.

6. The method of claim 1, further comprising:
determining a change at a local site; and
reconfiguring the aggregated media capabilities according to the change.

7. The method of claim 6, wherein determining a change comprises determining an addition of equipment to the local site, further comprising providing an additional slave device to associate with the equipment added.

8. The method of claim 1, further comprising receiving an initiated call from an endpoint in a local site if a remote site provides video capabilities.

9. A method for providing media capabilities to a master device for aggregation to facilitate video telephony, comprising:
providing at least two devices that support video or audio communication;
identifying one of the devices as a master device;
identifying at least one of the devices as a slave device; and
providing media capabilities to the master device for aggregation to facilitate video telephony.

10. The method of claim 9, further comprising receiving information from the master device, wherein the information comprises instructions on communicating video streams to the master device.

11. The method of claim 9, further comprising:
receiving a first video stream from an associated camera;
encoding the first video stream; and
directing the first video stream to the master device for aggregation with encoded video streams of slave devices and the master device.

12. The method of claim 9, further comprising:
receiving a second video stream associated with the slave device from the master device;
decoding the second video stream; and
communicating the second video stream to a display associated with the slave device.

13. A method for communicating with a remote site using video telephony, comprising:
registering with a call manager, wherein a videoconferencing system communicates with an endpoint by registering with the call manager;
receiving an inbound signal from a remote site based on registration;
providing media capabilities to the remote site; and
initiating video telephony communication with the remote site according to the received inbound signal and the media capabilities.

14. The method of claim 13, wherein initiating the video telephony communication comprises using the videoconferencing system to initiate the video telephony communication.

15. The method of claim 13, further comprising transferring the video telephony communication to the videoconferencing system when the video telephony communication is initiated.

16. A method for communicating with a remote site using video telephony, comprising:
registering with a call manager, wherein a videoconferencing system communicates with an endpoint by registering with the call manager;
determining an identifier of a remote site;
communicating the identifier to the call manager to initiate a video telephony communication with the remote site;
providing media capabilities to the remote site; and
initiating the video telephony communication with the remote site according to the media capabilities.

17. The method of claim 16, further comprising:
receiving media capabilities of the remote site; and
if the remote site media capabilities comprise video capabilities, transferring the video telephony communication to the videoconferencing system.

18. The method of claim 17, wherein transferring the video telephony communication comprises transferring the video telephony communication automatically when the media capabilities are received.

19. A method for configuring devices to facilitate video telephony, comprising:
providing at least two devices that support video or audio communication;
identifying one of the devices as a master device;
identifying at least one of the devices as a slave device;
determining media capabilities of the master device;
receiving the media capabilities of the slave device;
aggregating the media capabilities of the master device and the slave device;
communicating the aggregated media capabilities to a remote site to facilitate video telephony;
registering the aggregated media capabilities with a call manager;
negotiating with a remote site to determine whether the remote site is operable to receive the aggregated media capabilities;
determining a change at a local site, wherein determining a change comprises determining an addition of equipment to the local site, further comprising providing an additional slave device to associate with the equipment added;
reconfiguring the aggregated media capabilities according to the change;
receiving a first video stream from an associated camera;
receiving an audio stream from one or more microphones;
encoding the first video stream and the audio stream;
receiving a second video stream from the slave device;
combining the second video stream from the slave device and the first video stream from the associated camera into a third video stream;
communicating the audio stream and the third video stream to the remote site;
receiving the third video stream and the audio stream over a network, wherein the third video stream comprises the first video stream associated with the master devices and the second video stream associated with the slave device;
communicating the second video stream to the slave device;
decoding the first video stream associated and the audio stream;
communicating the decoded video stream to an associated display; and
communicating the decoded audio stream to speakers.

20. A method for providing media capabilities to a master device for aggregation to facilitate video telephony, comprising:
providing at least two devices that support video or audio communication;
identifying one of the devices as a master device;
identifying at least one of the devices as a slave device;
receiving information from the master device, wherein the information comprises instructions on communicating video streams to the master device;
providing media capabilities to the master device for aggregation to facilitate video telephony;
receiving a first video stream from an associated camera;
encoding the first video stream;
directing the first video stream to the master device for aggregation with encoded video streams of slave devices and the master device;
receiving a second video stream associated with the slave device from the master device;
decoding the second video stream; and
communicating the second video stream to a display associated with the slave device.
